(19) United States
(12) Patent Application Publication
(10) Pub. No.: US 2016/0207205 A1
(43) Pub. Date: Jul. 21, 2016

(54) Simulator

(71) Applicant: Buck Engineering & Consulting GmbH, Reutlingen (DE)

(72) Inventors: Matthias Buck, Reutlingen (DE); Oussama Ben Farah, Stuttgart (DE); Martin Gerlich, Stuttgart (DE)

(21) Appl. No.: 15/002,426

(22) Filed: Jan. 21, 2016

(30) Foreign Application Priority Data
Jan. 21, 2015 (EP) 15 000 165.9

(51) Int. Cl. B25J 13/00; B25J 19/00; B25J 9/10; B25J 9/12

(52) U.S. Cl. CPC B25J 13/00; B25J 9/12; B25J 19/0029; B25J 9/102

(57) ABSTRACT

A simulator is provided with a frame and a base supported on the frame. A robot arm is connected to the base and connected through the base to the frame. A receptacle for a user is provided. The receptacle has one or more input/output devices and is mounted on the robot arm. A simulation control device is connected by a data connection and an energy transmission connection to the one or more input/output devices. One or more electrical drives are connected to the robot arm and enable pivot movements about one or more rotary movement axes. A robot control device controls the one or more electric drives, wherein the robot control device is secured on the base. The base is supported on the frame so as to be continuously rotatable about a first one of the one or more rotary movement axes.

### BACKGROUND OF THE INVENTION

The invention relates to a simulator comprising a robot arm to which a receptacle for a user is secured wherein the receptacle comprises at least one input/output device that is connected by a data connection and by an energy transmission connection with a simulation control device. The simulator comprises a frame on which a base is supported so as to be continuously rotatable about a first rotary movement axis, wherein the robot arm is secured on the frame by means of the base. The robot arm comprises at least one electrical drive for performing a pivot movement about at least one rotary movement axis and the simulator comprises a robot control device for controlling the at least one electrical drive.

The invention relates further to a simulator comprising a robot arm to which a receptacle for a user is secured, wherein the simulator comprises a frame on which a base is supported so as to be rotatable about a first rotary movement axis. The robot arm is secured by means of the base on the frame. The robot arm comprises a rocker that is pivotable relative to the base by a second rotary movement axis. The robot arm comprises an arm section that relative to the rocker is pivotable about a third rotary movement axis. The robot arm comprises a hand section that enables pivot movements about a fourth rotary movement axis, a fifth rotary movement axis, and a sixth rotary movement axis.

US 2011/0207090 A1 discloses a simulator with a robot arm and with a movable base. The robot arm can be moved along a linear axis. The robot arm as well as the movable base, a control member, and the linear axis are controlled by a common computing and control unit.

In such simulators the computing and control unit which comprises the simulation control device and the robot control device is usually stationarily arranged and connected by energy lines and data lines with the individual drives and input/output devices that are to be controlled. Such a simulator has been developed by the Max Planck Institute in Túbingen, Germany, under the name MPI Cybermotion Simulator. In order to provide for a satisfactory freedom of movement for the movement of the receptacle for the user, the first axis about which the base is rotatably supported relative to the frame is designed in this simulator as a continuously rotating axis. For transmission of the energy from the robot control device to the individual drives of the robot arm, a plurality of slip rings between the frame and the base are provided.

It is the object of the invention to provide a simulator of the aforementioned kind that comprises a simplified configuration. A further object of the invention is to provide a simulator that provides further degrees of freedom for the movement of the receptacle for the user.

### SUMMARY OF THE INVENTION

In accordance with the present invention, the object is solved by a simulator having the robot control device secured to the base.

The object is further solved by a simulator in which the fourth rotary movement axis and the sixth rotary movement axis are designed as continuously rotating axes.

It is provided that the robot control device is secured on the base. The robot control device therefore rotates together with the base relative to the frame in operation. It is therefore no longer required to provide between the frame and the base a plurality of energy transmission connections, such as slip rings, for controlling the individual drives. Instead, the energy for the robot control device and all drives is transmitted by means of a common energy transmission connection from the frame to the base; the robot control device performs the control of the individual drives and the individual drives for this purpose are connected by means of separate energy transmission connections with the robot control device. In this context, the base can be in the form of an additional base or a rotating column of the robot arm in which the robot control device is integrated. By means of the continuously rotating axis between frame and base, a great movement space of the receptacle for the user is achieved. The continuously rotating axis is in this context an axis that enables a continuous rotary movement between frame and base. Neither the axis itself nor energy lines or data lines or the like limit the relative rotation mechanically. The robot arm can be a conventional industrial robot arm.

Advantageously, at least one slip ring (energy transmission slip ring) for transmission of energy from the frame to the base is provided by means of which the energy for the robot control device and the at least one electrical drive as well as the energy for the at least one input/output device of the receptacle is transmitted. In this context, the input/output device can be connected by a separate energy transmission connection to the robot control device. It is however preferred that a central energy supply is provided to which the individual consumers, such as the electrical drives and the input/output devices, are connected, in particular so as to be separately protected (fused). It can be provided that a single slip ring is provided for the transmission of energy from the frame to the base. The second phase can be formed by the robot arm itself. Advantageously, however, two, in particular three, slip rings are provided for the transmission of energy from the frame to the base by means of which the individual phases of the energy line are provided. Advantageously, a plurality of electrical drives and a plurality of input/output devices are provided and the energy for all electrical drives that are controlled by the robot control device and the energy for all input/output devices is transmitted by means of the at least one common slip ring for transmission of energy.

In this context, an input/output device can be an input device such as a joystick, a steering wheel, a keyboard or the like; an output device such as a screen, a projector or the like; or an input and output device such as a touchpad.

Advantageously, a slip ring (date slip ring) is provided for transmission of data from the frame to the base. In this context, the transmission of data from the frame to the base can be in principle realized by means of the at least one slip ring by means of which also the energy is transmitted from the frame to the base when the signals are appropriately superimposed. Preferably, for the transmission of data from the frame to the base however at least one slip ring is provided which is separate from the slip ring for transmission of energy. In particular, for transmission of data from the frame to the base two slip rings are provided by means of which the data are transmitted. By means of the slip ring for transmission of data, advantageously data for the robot control device as well as data for at least one input/output device are transmitted. For this purpose, the data are suitably coupled with each other, for example, by a bus system or the like. The two slip rings form then advantageously the lines of the bus system for sending data back and forth.

It can also be provided that the data are transmitted between the simulation control device and the input/output device at least partially by means of a wireless data connection. Accordingly, a data line that connects the simulation control device via the robot arm with the input/output device is not needed. Advantageously, the receptacle comprises an input/output control unit for control of the at least one input/output device. By means of the input/output control unit, the input/output device is advantageously connected to the simulation control device. The wireless data connection is advantageously a connection of the simulation control device with the input/output control device. The connection of the input/output control unit with one or a plurality of input/output devices can be realized in the receptacle in a simple way by cables.

In order to achieve a great movability range of the receptacle for the user, it is provided that the simulator comprises a linear axis on which the frame is secured and is movable together with the robot arm in the direction of a translatory movement axis. In operation, the simulation control device advantageously does not move together with the frame. The simulation control device is advantageously stationary within the space or room where the simulator is installed. However, it can also be provided to arrange the simulation control device on the base so that the simulation control device in operation can perform together with the frame a translatory movement. A plurality of linear axes that enable movements in the direction of a plurality of translatory movement axes can be advantageous also. Due to the arrangement of the robot control device within the base in case of a robot arm that is movably arranged on a linear axis, the entrainment of a plurality of lines by means of drag lines is not needed. Accordingly, wear and susceptibility of the simulator with regard to cable breakage is significantly reduced.

The robot arm is advantageously a buckling arm robot. The robot arm comprises advantageously at least five rotary movement axes. A sixth rotary movement axis is formed by the rotary movement axis between frame and base. A translatory movement axis can be formed by the linear axis. Also, further rotary movement axes or translatory movement axes can be advantageous.

Advantageously, the robot arm is designed similar to a conventional industrial robot. The robot arm comprises advantageously a rocker that is pivotable relative to the base about a second rotary movement axis. The rocker is advantageously pivotably supported by its first end on the base. The robot arm advantageously comprises an arm section that is pivotable relative to the rocker about a third rotary movement axis. In this context, the arm section is advantageously pivotably supported on the second end of the rocker. The robot arm comprises advantageously a hand section that enables pivot movements about a fourth rotary movement axis, a fifth rotary movement axis, and a sixth rotary movement axis. The arm section is advantageously pivotably supported by its first end on the rocker and the second end of the arm section is provided with the hand section. By arrangement of the robot control device on the base and not on the frame, an industrial robot of conventional configuration can be arranged on the base and can support the receptacle for the user.

Advantageously, the fourth rotary movement axis and the sixth rotary movement axis are aligned in parallel with each other in an aligned pivot position about the fifth rotary movement axis.

The fourth rotary movement axis is advantageously a continuously rotating axis. The fourth rotary movement axis and the fifth rotary movement axis are advantageously driven by electrical drives that are arranged on the end of the arm section which is facing away from the hand section. The transmission of rotary movement to the fourth and fifth rotary movement axes is realized in this context advantageously mechanically, for example, by means of connecting shafts. For driving the sixth rotary movement axis, advantageously an electrical drive is provided in the interior of the arm section which drives directly the sixth rotary movement axis. Advantageously, at least one slip ring is provided on the fourth rotary movement axis for the transmission of energy for the at least one input/output device. In this context, advantageously at least two, in particular three, slip rings for the individual phases of an energy line are provided. The at least one slip ring serves advantageously for transmission of energy to all electrical consumers provided on the receptacle for the user. It can also be provided that the receptacle is rotatable about a further rotary movement axis and an energy line for the further rotary movement axis is extending through the at least one slip ring or at least a further separate slip ring.

The sixth rotary movement axis is advantageously a continuously rotating axis. On the sixth rotary movement axis advantageously at least one slip ring for transmission of energy for the at least one input/output device is provided. When the fourth as well as the sixth rotary movement axes are designed as continuously rotating axes, by parallel orientation of the fourth and the sixth rotary movement axes and simultaneous rotary drive action about both axes in the same rotational direction a very high rotary speed of the receptacle for the user can be achieved. In order to achieve a high rotary speed of the receptacle for the user, it can be provided alternatively or in addition that a gearbox, in particular a planetary gearbox, is arranged on the sixth rotary movement axis.

The configuration of the fourth and the sixth rotary movement axes as continuously rotating axes represents an independent inventive concept that is independent of the arrangement of the robot control device on the base. The fourth rotary movement axis and the sixth rotary movement axis are designed in this context such that a continuous rotary movement, i.e., a rotary movement by an infinite number of revolutions is possible. The maximum possible rotation angle is neither limited by the construction of the rotary movement axis nor by energy lines or data lines or the like. Accordingly, additional degrees of freedom for the movement of the receptacle for the user are provided in a simulation. Rotary movements for any number of revolutions about the fourth and/or the sixth rotary movement axis are possible. Due to the configuration of the fourth and the sixth rotary movement axes as continuously rotating axes, the receptacle, in particular for parallel orientation of the fourth and the sixth rotary movement axes, can perform very fast rotary movements. Accordingly, a simulation that is very close to reality is possible.

### BRIEF DESCRIPTION OF THE DRAWING

FIG. 1 is a schematic side view of a simulator.

FIG. 2 is a schematic side view of another simulator.

FIG. 3 is a schematic side view of yet another simulator.

FIG. 4 is a schematic illustration of the control devices of the simulator.

### DESCRIPTION OF THE PREFERRED EMBODIMENTS

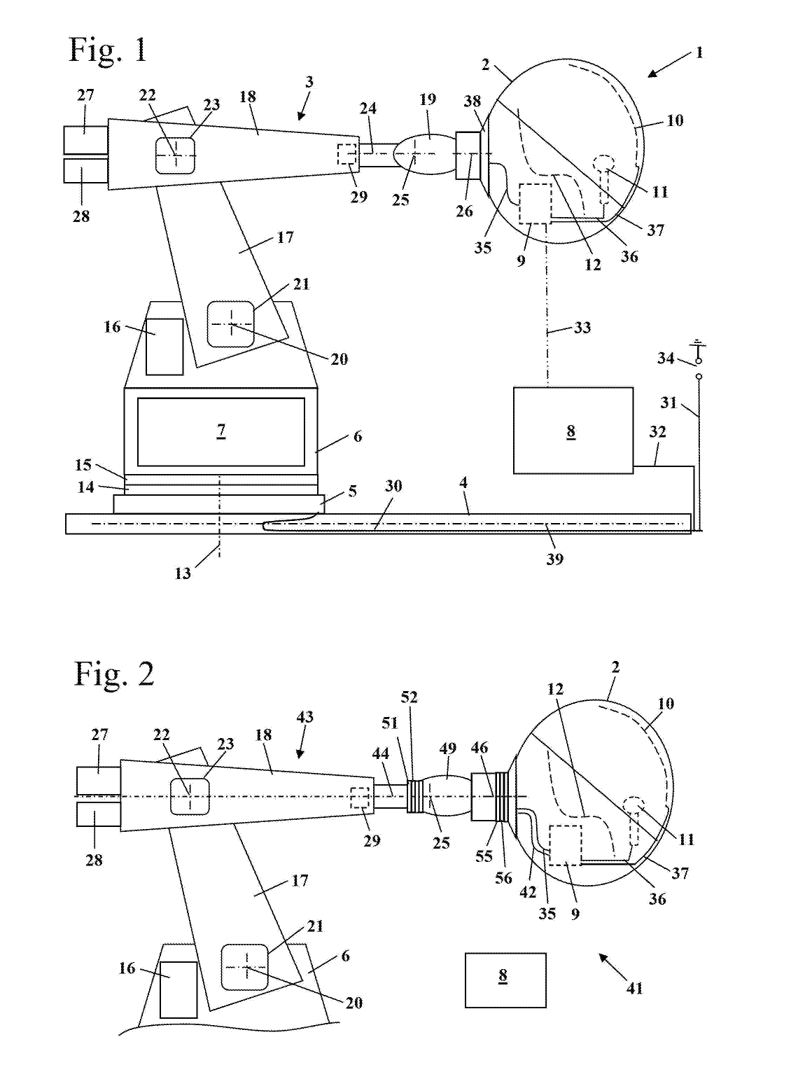

FIG. 1 shows schematically a simulator 1. The simulator 1 can be used, for example, for simulating the driving behavior of a vehicle or the flying behavior of an airplane. For this purpose, the simulator 1 comprises a receptacle 2 for a user. The receptacle 2 is designed in the embodiment as a closed capsule in which a seat 12 for the user is provided. In the receptacle 2, input/output devices are provided. In this context, input/output devices are input devices, output devices, or devices that enable input as well as output such as a touchpad. In the embodiment, the output device is a screen 10 and the input device is a joystick 11. Instead of the joystick 11 also a steering wheel or the like can be provided. Instead of the screen 10, one or a plurality of projectors can be also provided that project an image onto a projection surface. A plurality of other and/or additional input/output devices can be provided. The number and type of input/output devices is advantageously designed as a reproduction of a vehicle or airplane to be simulated. For controlling the input/output devices, in the embodiment an input/output control unit 9 is provided in the receptacle 2 and is connected by an energy and data line 36 with the joystick 11 and by means of an energy and data online 37 with the screen 10. The energy line and the data line can also be designed as separate lines, respectively. By means of the input/output control unit 9, the display on the screen 10 is controlled in accordance with the movement that has been input by the user by means of the joystick 11 and in accordance with the simulation to be performed.

The receptacle 2 is secured on a robot arm 3. By means of the robot arm 3, the receptacle 2 can be moved and rotated in space. In the embodiment, the robot arm 3 is movable along a linear axis 4 in the direction of a translatory movement axis 39 in space. Frame 5 is secured on the linear axis 4. On the frame 5, a base 6 of the robot arm 3 is supported so as to be continuously rotatable about a first rotary movement axis 13. For performing the rotary movement of the base 6 relative to the frame 5 about the first rotary movement axis 13, a first electrical drive 16 is arranged on the base 6.

The base 6 in the embodiment is the rotating column of the robot arm 3. The base 6 can however also be a separate element on which a rotating column of a robot arm is secured. On the base 6, a rocker or link arm 17 is pivotably supported by one of its ends so as to be pivotable about a second rotary movement axis 20. For carrying out the pivot movement of the rocker 17 about the second rotary movement axis 20, a second electrical drive 21 is provided which is secured on the rocker 17 in the embodiment. On the end of the rocker 17 facing away from the base 6, an arm section 18 is pivotably supported so as to pivot about a third rotary movement axis 22. For carrying out the rotary movement about the third rotary movement axis 22, a third electrical drive 23 is arranged on the arm section 18. The arm section 18 comprises a free end on which a hand section 19 is arranged. The hand section 19 enables rotational movements about a fourth rotary movement axis 24 oriented in longitudinal direction of the arm section 18; about a fifth rotary movement axis 25 oriented perpendicular to the fourth rotary movement axis 24; as well as about a sixth rotary movement axis 26 oriented perpendicular to the fifth rotary movement axis 25. In the aligned pivot position of the hand section 19 pivoted about the fifth rotary movement axis 25 as illustrated in FIG. 1, the fourth rotary movement axis 24 and the sixth rotary movement axis 26 are oriented parallel to each other. In the embodiment, the arrangement is such that rotary movement axes 24 and 26 coincide in this aligned pivot position.

The receptacle 2 comprises a connecting flange 38 with which it is secured on the hand section 19. In the embodiment, the connecting flange 38 is arranged behind the back of the user when the user is seated on the seat 12. When the user is seated upright on the seat 12, the sixth rotary movement axis 26 is approximately horizontal in the embodiment.

For controlling the simulator 1, a simulation control device 8 is provided. The simulation control device 8 in the embodiment is stationarily arranged within space. Upon movement of the frame 5 along the linear axis 4 or upon movements of the robot arm 3 about the rotary movement axes 13, 20, 22, 24, 25, 26, the simulation control device 8 is thus not moved. Alternatively, it can be provided that the simulation control device 8 is arranged in the base 6 and, in operation, is moved together with the frame 5 and the base 6 in the translatory movement direction 39. In this context, the simulation control device 8 can be connected by wireless connections and/or by connecting lines with peripheral devices such as the input/output control unit 9.

Large distances are covered when a real vehicle or airplane actually moves or travels. The movement range of the receptacle 2 of the simulation device 1 is significantly smaller. Despite of this, in order to let the user still experience the sensation of actually traveling a distance, the simulation control device 8 calculates the movement to be simulated into a movement with reduced travel distance which lets the user experience a sensation as close to reality as possible. In this context, as it is known in the art, the accelerations that are experienced by the user upon movement of the vehicle or airplane are simulated by appropriate movements of the receptacle 2 and appropriate visualization on the screen 10.

For carrying out the rotary movements about the rotary movement axes 24, 25, and 26, a fourth electrical drive 27, a fifth electrical drive 28, and a sixth electrical drive 29 are provided in the embodiment. The fourth electrical drive 27 and the fifth electrical drive 28 are arranged on the end of the arm section 18 that is facing away from the hand section 19. The rotational movement is transmitted mechanically by the electrical drives 27, 28, in particular by connecting shafts, to the rotary movement axes 24 and 25. The sixth electrical drive 29 is arranged in the end of the arm section 18 which is facing the hand section 19 and drives the sixth rotary movement axis 26.

A robot control device 7 is provided for controlling the electrical drives 16, 21, 23, and 27 to 29 of the robot arm 3. The robot control device 7 is connected by separate connecting lines, not illustrated, with the individual drives 16, 21, 23, and 27 to 29. The rocker 17 and the arm section 18 each can be pivoted about the pivot axes 20 and 22 only by a predetermined angular range. Accordingly, an electrical connection by means of an appropriately arranged cable is possible. The first rotary movement axis 13 is however designed as a continuously rotating axis. The energy supply of the robot control device 7 and of the electrical drives 16, 21, 23, and 27 to 29 must therefore be realized by electrical connections that enable a continuous relative rotation of the base 6 relative to the frame 5. In the embodiment, for this purpose a slip ring (energy transmission slip ring) 15 between frame 5 and base 6 is provided. A further slip ring (data slip ring) 14 serves for transmitting the data between the frame 5 and the base 6. As is schematically illustrated in FIG. 1, the simulation control device 8 is connected by a data line 32 with the frame 5. An energy line 31 which is connected to an energy source 34 is also extended to the frame 5. On the linear axis 4, lines 31 and 32 are guided within a drag line 30. The energy is transmitted from the frame 5 to the base 6 by means of the slip ring 15 and the data are transmitted through the slip ring 14. The slip rings 14 and 15 can each be a single slip ring. Advantageously, the energy transmission however takes place through two, in particular three, slip rings by means of which the individual phases and the neutral lead of an energy line are provided.

Since the robot control device 7 is arranged on the base 6 and is not stationary within the space as is the case for the simulation control device 8, the entire energy for the robot control device 7 and all electrical drives of the robot arm 3 can be transmitted through one or a plurality of common slip rings 15. For a plurality of slip rings 15, the energy for all drives is commonly transmitted and not separately for each one of the drives by means of separate slip rings. Also, energy supply for the receptacle 2, the input/output control unit 9 as well as the joystick 11 and the screen 10 can be realized through the slip ring 15.

For transfer of the data from the simulation control device 8 to the robot control device 7, the slip ring 14 is provided. A single slip ring 14 for data transmission can be provided. Advantageously, however at least two slip rings 14 are provided which serve as a feed and return line of a closed current circuit. The data transmission is realized in particular by means of a bus system. Advantageously, only the data for the robot control device 7 are transmitted through the slip ring 14. In the embodiment, it is provided that between the simulation control device 8 and the input/output control unit 9 a wireless data connection 33, for example, a radio connection, a Bluetooth connection or the like, is existing through which the data between simulation control device 8 and input/output control unit 9 can be transmitted wireless. It can also be provided that also the data of the simulation control device 8 are also transmitted to the input/output control unit 9 through the slip ring 14 and appropriate cables. The input/output control unit 9 is supplied with energy by an energy line 35. Advantageously, the input/output control unit 9 is connected with the energy source 34 and protected (fused) separately. However, it can also be provided that the input/output control unit 9 is connected by the robot control device 7 with the energy source 34.

FIG. 2 shows a simulator 41 whose configuration substantially corresponds to that of simulator 1. Same reference characters identify elements that correspond with each. The simulator 41 is shown in FIG. 2 in a detail view. Elements that are not illustrated correspond to those of the simulator 1.

The simulator 41 comprises a robot arm 43. The robot arm 43 comprises a hand section 49 which is arranged on the arm section 18 and comprises a fourth rotary movement axis 44 which is designed as a continuously rotating axis. The hand section 49 comprises moreover a fifth rotary movement axis 25 as well as a sixth rotary movement axis 46 which is also designed as a continuously rotating axis.

In the embodiment according to FIG. 2, data as well as energy are transmitted through cables to the input/output control unit 9. Energy line 35 is provided for transmission of energy. Data connection 42 is provided for transmission of data and connects the input/output control unit 9 with the robot control device 7, not shown in FIG. 2. By means of the continuously rotating axes 44 and 46, data and energy are transmitted for the input/output control unit 9 by means of slip rings in the embodiment. A first slip ring 51 for transmission of data to the input/output control unit 9 and a second slip ring 52 for transmission of energy to the input/output control unit 9 are provided at the fourth rotary movement axis 44. At the sixth rotary movement axis 46, a first slip ring 55 for transmission of data to the input/output control unit 9 as well as a second slip ring 56 for transmission of energy to the input/output control unit 9 are provided. The slip rings 51, 52, 55, and 56 can also be comprised of a plurality of slip rings for individual phases of an energy line or a data line.

In the pivot position of the hand section 49 relative to the fifth rotary movement axis 25 illustrated in FIG. 2, the fourth rotary movement axis 44 and the sixth rotary movement axis 46 are parallel to each other and are coinciding in the embodiment. When the hand section 49 performs rotational movements in the same rotational direction about the fourth rotary movement axis 44 as well as about the sixth rotary movement axis 46, a rotational movement of the receptacle 2 with very heigh rotary speed can be achieved.

The configuration of the fourth rotary movement axis 44 and of the sixth rotary movement axis 46 as continuously rotating axes can also be provided for a simulator in which the robot control device 7 is not secured on the base 6 and/or in which the first rotary movement axis 13 is not designed as a continuously rotating axis. Continuously rotating axes in the meaning of the present invention are rotary movement axes that enable a plurality of revolutions in the same rotary direction and have no limitation for the rotary movement, neither mechanically by the construction of the axis itself nor by lines such as energy lines and data lines or the like.

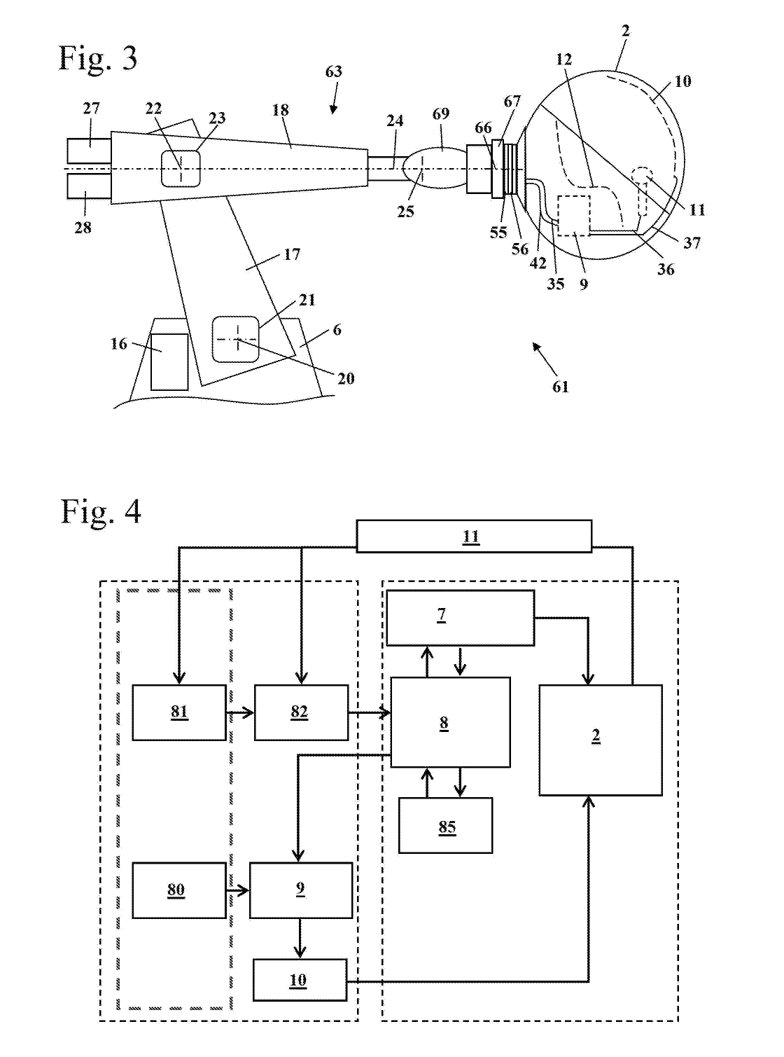

FIG. 3 shows an embodiment of a simulator 61 comprising a robot arm 63. Same reference numerals indicate same elements as in the preceding Figures; the area of the linear axis 4 of the simulator 61 that is not illustrated in FIG. is embodied to correspond to the embodiment of FIG. 1.

The robot arm 63 comprises a hand section 69. The hand section 69 comprises a fourth rotary movement axis 24 and a fifth rotary movement axis 25 which enable pivot movements only about a predetermined angular range. The hand section 69 comprises a sixth rotary movement axis 66 which is designed as a continuously rotating axis. On the sixth rotary movement axis 66 a gearbox 67 between the drive part and the output part is provided. The gearbox 67 in the embodiment is designed as a planetary gearbox. Accordingly, a very high rotary speed about the sixth rotary movement axis 66 can be achieved. The simulators 41 and 61 enable advantageously rotational movements about the sixth rotary movement axis 46, 66 with angular speeds of more than 360° per second.

In the embodiment according to FIG. 3, the input/output control unit 9 is connected by a cable-based data connection 42 with the simulation control device 8. A first slip ring 55 for transmission of data to the input/output control unit 9 as well as a second slip ring 56 for transmission of energy to the input/output control unit 9 are provided on the sixth rotary movement axis 66. Here also several slip rings for transmission of different phases of an energy line or of lines of a data line for sending date back and forth can be provided.

FIG. 4 illustrates schematically the function of the simulators 1, 41, and 61. The basis for the simulation is a model 80 of the environment that represents three-dimensionally the environment visible from the vehicle. The vehicle can be a motor vehicle or an airplane. As input parameters for the simulation also a movement model 81 is provided that provides data for movement of the vehicle. The model 80 of the environment is processed in the input/output control unit 9 in accordance with the simulated driving or flying maneuvers and the image to be displayed is shown on the screen 10 in the receptacle 2. Instead of the screen 10, projectors or the like can be provided also. Processing of the model 80 of the environment can be realized partially or completely in the simulation control device 8.

Based on the movement model 81, the movement to be carried out by the receptacle 2 is calculated in the movement simulation 82. Processing of the data can be carried out in a separate computer or within the simulation control device 8. The simulation control device 8 is coupled with a collision avoidance device 85 that determines for each movement to be carried out by the robot arms 3, 43, 63 whether the movement can be performed without a collision. The simulation control device 8 is connected with the robot control device 7 and provides data to the robot control device 7 as to how the receptacle 2 is to be moved in space. The simulation control device 8 controls also the linear axis 4 appropriately. In the receptacle 2, an user senses the movements that are generated by the robot control device 7 and that cause the same sensation as the movement that is to be simulated. At the same time, the user can see the image that is generated on the screen 10. In this way, a realistic simulation is achieved. By means of the joystick 11, the user influences the simulation. By means of the joystick 11, the user can control the simulated vehicle. In accordance with the control commands which are input by means of the joystick 11, a movement of the receptacle 2 and an image to be displayed within the receptacle 2 are calculated.

It has been found that each person perceives movements of the receptacle 2 differently. In order to be able to perform a simulation as realistically as possible, it is provided that, prior to the actual simulation, a calibration of the simulator 1, 41, 61 is performed in which the perception thresholds or limits of the user in respect to rotational movements and translatory movements are determined and taken into consideration during the movement simulation. The perception thresholds or limits can be utilized, for example, for determining minimum movements that are still being sensed by the user or maximum movements that are not sensed by the user. For determining the perception threshold for a rotational movement, it is provided to perform a rotational movement with the receptacle 2 and the user seated therein. The speed of rotation is increased until an user senses the rotation. The point in time when the user senses the rotation can be input, for example, through an input device by the user. The rotational movement that is still barely noticed as a rotation by the user is then utilized in the movement simulation 82 for determining the movements to be carried out by the robot arm 3.

Since only limited space is available for the simulator 1, 41, 61 for performing movements, the simulator 1, 41, 61 is always moved back at very minimal speed into its initial position during the entire simulation. The very minimal speed, the so-called washout speed, is selected to be so minimal that an user cannot sense it. For calibration of a simulator 1, 41, 61, it is provided to determine the washout speed which is sensed by the user. This speed also is taken into account in the movement simulation 82. For this purpose, the perception threshold of a user is determined for translatory movement. By calibration of the simulation device, the movement simulation 82 is not performed with fixed values for the washout speed and for the rotary speeds but the speeds for rotational and translatory movements that are still barely sensed by the user and have been determined by calibration are utilized in the simulation. In this way, a particularly realistic simulation is achieved.

The specification incorporates by reference the entire disclosure of European priority document 15 000 165.9 having a filing date of Jan. 21, 2015.

While specific embodiments of the invention have been shown and described in detail to illustrate the inventive principles, it will be understood that the invention may be embodied otherwise without departing from such principles.

What is claimed is:

1. A simulator comprising:
a frame;
a base supported on the frame;
a robot arm connected to the base and connected through the base to the frame;
a receptacle for a user, wherein the receptacle comprises one or more input/output devices and is mounted on the robot arm;
a simulation control device connected by a data connection and an energy transmission connection to the one or more input/output devices;
one or more electrical drives operatively connected to the robot arm to cause the robot arm to perform a pivot movement about one or more rotary movement axes;
a robot control device configured to control the one or more electric drives;
wherein the robot control device is secured on the base;
wherein the base is supported on the frame so as to be continuously rotatable about a first one of the one or more rotary movement axes.

2. The simulator according to claim 1, further comprising one or more energy transmission slip rings configured to transmit energy from the frame to the base, wherein through the one or more energy transmission slip rings energy is transmitted for the robot control device, for the one or more electrical drives, and for the one or more input/output devices of the receptacle.

3. The simulator according to claim 2, wherein only one of the energy transmission slip rings is provided and is configured as a common energy transmission slip ring, wherein a plurality of the electrical drives and a plurality of the input/output devices are provided, and wherein energy for all of the plurality of the electrical drives controlled by the robot control device and energy for all of the plurality of the input/output devices is transmitted by the common energy transmission slip ring.

4. The simulator according to claim 1, further comprising a data slip ring configured to transmit data from the frame to the base.

5. The simulator according to claim 4, wherein the data slip ring transmits data for the robot control device and data for the one or more input/output devices.

6. The simulator according to claim 1, wherein the data connection connecting the simulation control device to the one or more input/output devices comprises a wireless data connection through which data are transmitted for the one or more input/output devices.

7. The simulator according to claim 1, wherein the receptacle comprises an input/output control unit configured to control the one or more input output devices, wherein the one or more input/output devices are connected through the input/output control unit to the simulation control device.

8. The simulator according to claim 1, further comprising a linear axis that defines a translatory movement axis, wherein the frame is secured on the linear axis, and wherein the frame together with the robot arm is configured to move along the linear axis in a direction of the translatory movement axis.

9. The simulator according to claim 1, wherein the robot arm comprises at least five of the rotary movement axes.

10. The simulator according to claim 9, wherein the robot arm comprises a rocker which, relative to the base, is pivotable about a second one of the rotary movement axes, wherein the robot arm further comprises an arm section that, relative to the rocker, is pivotable about a third one of the rotary movement axes, and wherein the robot arm further comprises a hand section that enables pivot movements about a fourth one of the rotary movement axes, about a fifth one of the rotary movement axes, and about a sixth one of the rotary movement axes.

11. The simulator according to claim 10, wherein the fourth rotary movement axis and the sixth rotary movement axis have an aligned pivot position when pivoted about the fifth rotary movement axis, wherein in the aligned pivot position the fourth rotary movement axis and the sixth rotary movement axis are parallel to each other.

12. The simulator according to claim 10, wherein the fourth rotary movement axis is a continuously rotating axis.

13. The simulator according to claim 12, further comprising at least one slip ring arranged on the fourth rotary movement axis, wherein the at least one slip ring transmits energy for the one or more input/output devices.

14. The simulator according to claim 10, wherein the sixth rotary movement axis is a continuously rotating axis.

15. The simulator according to claim 14, further comprising at least one slip ring arranged on the sixth rotary movement axis, wherein the at least one slip ring transmits energy for the one or more input/output devices.

16. The simulator according to claim 15, further comprising a gearbox arranged on the sixth rotary movement axis.

17. A simulator comprising:
a frame;
a base rotatably supported on the frame so as to rotate about a first rotary movement axis;
a robot arm connected to the base and connected through the base to the frame;
a receptacle for a user, wherein the receptacle is secured on the robot arm;
wherein the robot arm comprises a rocker that, relative to the base, is pivotable about a second rotary movement axis;
wherein the robot arm further comprises an arm section that, relative to the rocker, is pivotable about a third rotary movement axis;
wherein the robot arm further comprises a hand section enabling pivot movements about a fourth rotary movement axis, a fifth rotary movement axis, and a sixth rotary movement axis;
wherein the fourth rotary movement axis and the sixth rotary movement axis are configured as continuously rotating axes.
